(19) United States
(12) Patent Application Publication
(10) Pub. No.: US 2007/0033073 A1
(43) Pub. Date: Feb. 8, 2007

(54) SYSTEM AND USER INTERFACE FOR MONITORING PATIENT TREATMENT ORDERS

(75) Inventors: Reza Tajaliawal, Miami, FL (US); James McAvoy, Pottstown, PA (US)

Correspondence Address: ALEXANDER J BURKE, 3 GLENSIDE TERRACE, UPPER MONTCLAIR, NJ, 07043, US

(73) Assignee: SIEMENS MEDICAL SOLUTIONS HEALTH SERVICES CORPORATION, MALVERN, PA (US)

(21) Appl. No.: 11/420,246

(22) Filed: May 25, 2006

Related U.S. Application Data
(60) Provisional application No. 60/705,809, filed on Aug. 5, 2005.

(51) Int. Cl. G06F 19/00

(52) U.S. Cl. 705/3

(57) ABSTRACT

A Medication Reconciliation and Workflow system reconciles active medication orders in response to transitions in care setting and documents and automatically communicates reconciled medication information using electronic (e.g., HL7 CDA format) transactions and network (or other electronic) interfaces. A medication reconciliation system uses a detector for detecting a transition in care setting of a particular patient. A treatment validation processor, in response to a detected transition in care setting of the particular patient, automatically initiates review and safety checking of medications prescribed for the particular patient and provides information to a user enabling user validation of the review and safety checking. A documentation processor updates a medical record of the particular patient to include a record of the user validation and review, in response to a command by the user.

This is a non-provisional application of provisional application Ser. No. 60/705,809 by Reza Tajaliawal et al. filed Aug. 5, 2005.

### FIELD OF THE INVENTION

This invention concerns a system for reconciling treatments and medications of a patient and safety checking and validating treatments and medications, in different care settings.

### BACKGROUND OF THE INVENTION

It is necessary to accurately and completely reconcile medications (and treatments) during the care of a patient. Medication reconciliation comprises taking a patient's home medication list (medications prior to admission) and comparing it to the patient's current active medication orders (or, in the case of admission, this may be the medications being considered for ordering), to create a new medication list for the next care setting or a discharge medication list for a patient to use at home. In a hospital setting, medication reconciliation occurs at admission, charge in level or setting of care (i.e. transfer within a hospital), and at discharge. Existing systems typically provide manually recorded documentation of a medication reconciliation review and depend upon informal review processes. The existing manual processes depend upon skills within an organization and involve personnel remembering to review medication orders upon particular events and require manual documentation for inclusion in a patient medical record. The existing manual processes may be erratic, time consuming and burdensome and produce inconsistent, inaccurate results. A system according to invention principles addresses these deficiencies and related problems.

### SUMMARY OF THE INVENTION

A Medication Reconciliation and Workflow system reconciles active medication orders at transitions of care (e.g. admission, transition between different levels of care and service and discharge) and documents and communicates reconciled medication information using electronic (e.g., HL7) transactions. A medication reconciliation system uses a detector for detecting a transition in care setting of a particular patient. A treatment validation processor, in response to a detected transition in care setting of the particular patient, automatically initiates review and safety checking of medications prescribed for the particular patient and provides information to a user enabling user validation of the review and safety checking. A documentation processor updates a medical record of the particular patient to include a record of the user validation and review, in response to a command by the user.

### BRIEF DESCRIPTION OF THE DRAWING

FIG. 1 shows Hospital Information System (HIS) including a medication reconciliation system, according to invention principles.

FIG. 2 shows a flowchart of a process used by a medication reconciliation system for reconciling orders for medications upon care setting transition, according to invention principles.

FIG. 3 shows a flowchart of a further process used by a medication reconciliation system for reconciling orders for medications upon care setting transition, according to invention principles.

FIG. 4 shows a sheet for user interface display image supporting medication reconciliation, according, to invention principles.

FIG. 5 shows a flowchart of a process used by a medication reconciliation system, according to invention principles.

### DETAILED DESCRIPTION OF THE INVENTION

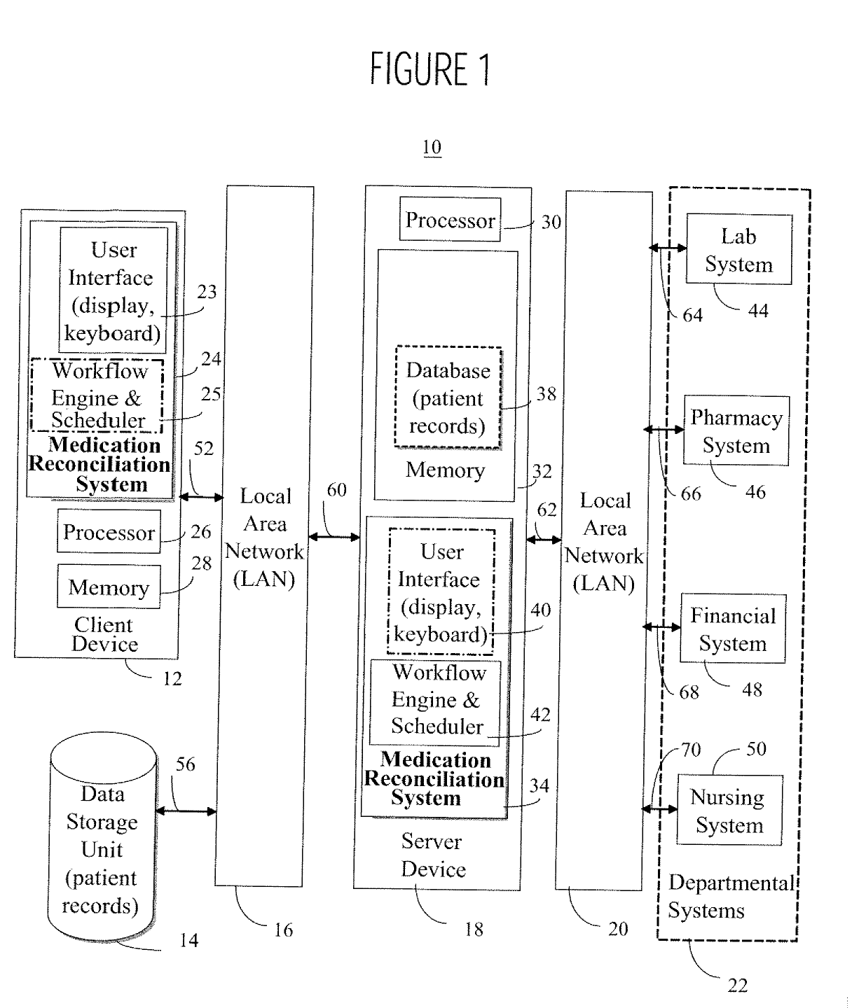

FIG. 1 shows a Medication Reconciliation and Workflow system automating audit and verification of active medication orders in response to a transition in patient care setting. The system automatically initiates a medication review process upon detection of change of service or when a care location changes. The system provides consistent and accurate evaluation documentation according to standards (e.g., National Patient Safety Goal guidelines). A medication reconciliation review is automatically triggered using an automatic process in response to admission, transfer, discharge or similar changes of services and provides a uniform system to access information using rules, reminders, automated Workflow, and a computer generated template of medications.

The Medication Reconciliation and Workflow system automatically initiates reconciliation of active medication orders in response to a transition in patient care setting including, upon admission at a hospital, upon transition between different levels of care and service and upon discharge from a hospital. Reconciliation comprises identifying, duplicate, incompatible and replicated medications and associated dosages being taken (or previously taken) by a patient using information from different sources (e.g., communication with the patient, medical records produced by patient healthcare providers). Reconciliation also comprises identifying when a drug has been administered in one setting of care or service and the same drug ordered in another setting of care or service does not overlap the previous order and removes a situation where the drug is administered too soon, causing a drug overdose. Reconciliation further comprises identifying, different or incompatible method of administration (routing) or incompatibilities with medication administration rules of a healthcare facility. Reconciliation also comprises generating a consolidated new medication prescription list that resolves duplicate, incompatible and replicated medications as well as dosage and administration incompatibilities by providing a single list of medications, dosages and routing that are compatible and valid following a drug interaction, conflict check and administration review and verification. The system automatically documents reconciliation actions and initiates generation of electronic transactions providing medication review information and a reconciled consolidated medication list of a patient to other computer systems using HL7 transactions (e.g., CDA format) via a network and electronic interfaces.

The system supports patient safety medication management best practices and Joint Commission on Accreditation of Healthcare Organizations (JCAHO) continuity of care guidelines (e.g. Patient Safety Goal 2005) requiring healthcare providers to “accurately and completely reconcile medications across the continuum of care”, and reduces adverse drug events (ADE). The system performs reconciliation (with or without healthcare worker interaction) by comparing a patient home medication list (list of medications taken prior to admission) with a patient current active medication orders (or, in the case of admission, this may be the medications being considered for ordering), to create a new consolidated medication list for a next care setting or discharge medication list.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example, A display processor or generator is a known element comprising electronic circuitry or software or a combination of both for generating display images or portions thereof. A user interface comprises one or more display images enabling user interaction with a processor or other device.

FIG. 1 shows a networked Hospital Information System (HIS) 10 including a medication reconciliation and Workflow system 34. Medication reconciliation and Workflow system 34 reconciles active medication orders in response to a transition in patient care setting including, upon admission at a hospital, upon transition between different levels of care and service and upon discharge from a hospital. Medication reconciliation and Workflow system 34 may alternatively be located in client device 12 as unit 24 (or elsewhere in a network employed by system 10). Medication reconciliation and Workflow system 34 includes Rules Engine, Workflow Engine and task scheduler 42 and user interface 40. Client device 12, preferably implemented as a personal computer, also includes a processor 26, and a memory unit 28. Processor 26 and memory unit 28 are constructed and operate in a manner well known to those skilled in the art of the design of client devices.

Medication reconciliation system 24 in client device 12 includes corresponding Workflow engine 25 and task scheduler 23. Medication Reconciliation and Worlkflow system 34 employs structured user best practice rules in memory 32 that are automatically initiated when an Admission, Discharge and Transfer (ADT) or similar change of service or care setting of a patient occurs. System 34 reviews active medications of a patient in response to a change in care setting location of the patient so that dosage and method of administration of medication compatible with care setting medication administration rules are applied. System 34 documents changes in medications and associated dosages and methods of administration electronically by communicating data in HL7 transaction format to departmental systems 22, storage unit 14, memory 32 and client device 12. System 10 maintains an audit record in memory 32 (or unit 14 or device 12) indicating changes made to patient medication in response to a reconciliation process performed by system 34 (with or without manual interaction) implementing industry best practices compatible with review organization (e.g., JCAHO) and national patient safety guidelines.

Healthcare information system 10 generally includes a client device 12, a data storage unit 14, a first local area network (LAN) 16, a server device 18, a second local area network (LAN) 20, and departmental systems 22. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

User interface 40 in medication reconciliation and Workflow system 34 generally includes an input device that permits a user to input information and an output device that permits a user to receive information. Preferably, the input device is a keyboard and mouse, but also may be a touch screen or a microphone with a voice recognition program, for example. The output device is a display, but also may be a speaker, for example. The output device provides information to the user responsive to the input device receiving information from the user or responsive to other activity the client device 12. For example, the display presents information responsive to the user entering information via the keyboard.

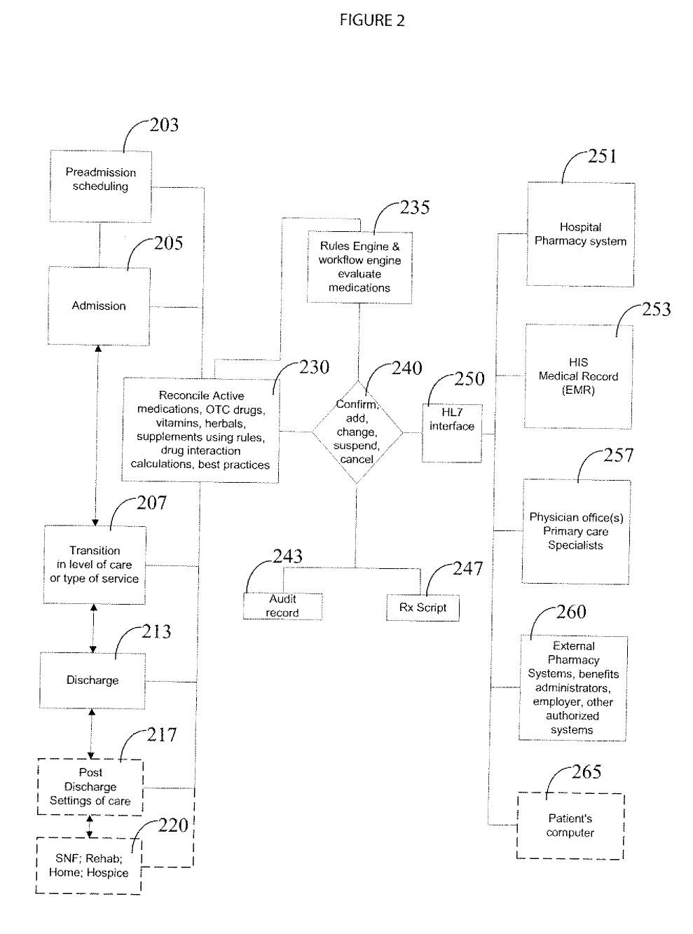

FIG. 2 shows a flowchart of a process used by medication reconciliation system 34 for reconciling orders for medications upon care setting transition. Medication reconciliation system 34 in step 230 initiates reconciliation of patient active medications, over the counter medications, vitamins, herbal medications and supplements as well as associated dosages and methods of administration following predetermined instruction in memory 32 in response to transitions in care setting. The processor executed instructions implement rules, drug interaction checks, calculations and best practices. The transitions in care setting comprise, upon preadmission scheduling 203, admission 205, transition in level of care or type of service 207, discharge 213, change in post discharge settings of care 217 and change in specialized nursing facility (SNF), rehabilitation facility, home or hospice 220. Rules and Workflow engine and scheduler 42 in medication reconciliation system 34 in step 235 evaluates patient medications by identifying, duplicate, incompatible and replicated medications and associated dosages being taken (or previously taken) by a patient using information from different sources (e.g., from communication with the patient or from medical records produced by patient healthcare providers).

Rules and Workflow engine 42 identifies, duplicate, incompatible and replicated medications by text comparison of medication names and codes. Engine 42 also uses medication code mapping information containing industry standard and other mapping information to support identifying duplicate or replicated medications. Medication code sets and identifiers used include HIPAA (Health Information Portability and Accountability Act) compatible code sets and other code sets used in a health care operation. Such code sets include, for example, ICD (International Classification of Diseases) codes, 9th Edition, Clinical Modification, (ICD-9-CM), Volumes 1, 2 and 3, as well as ICD-10 maintained and distributed by the U.S. Health and Human Services department. The code sets also include code sets compatible with HCPCS (Health Care Financing Administration Common Procedure Coding System), NDC (National Drug Codes), CPT-4 (Current Procedural Terminology), Fourth Edition CDPN (Code on Dental Procedures and Nomenclature). Further the code sets and terms include code sets compatible with SNOMED-RT “Systernaticized Nomenclature of Medicine, Reference Terminology” by the College of American Pathologists, UMLS (Unified Medical Language System), by the National Library of Medicine, LOINC Logical Observation Identifiers, Names, and Codes Regenstrief Institute and the Logical Observation Identifiers Names and Codes (LOINC®) Committee, Clinical Terms also known as “Read Codes”, DIN Drug Identification Numbers, Reimbursement Classifications including DRGs (Diagnosis Related Groups). The code sets also include code sets compatible with CDT Current Dental Terminology, NIC (Nursing intervention codes) and Commercial Vocabulary Services (such as HealthLanguage by HealthLanguage Inc., by Apelon Inc.) and other code sets used in healthcare.

Rules and Workflow engine 42 identifies different or incompatible methods of administration (routing) or incompatibilities with medication administration rules of a new healthcare facility. Rules and Workflow engine 42 generates a proposed consolidated new medication prescription list that resolves duplicate, incompatible and replicated medications as well as administration incompatibilities by providing a single list of medications, dosages and routing that are compatible and valid in response to a drug interaction check, conflict check and administration review and verification. System 34 in step 240, in one embodiment, enables a user via user interface 40 to confirm medications in the list, change medications in the consolidated list, suspend medications in the consolidated list or add medications to the list in response to user command. User interface 40 provides display of one or more images indicating a proposed consolidated medication list supporting user review and edit of the proposed consolidated medication list. Rules and Workflow engine 42 in response to user command in step 240 generates a consolidated new medication prescription list that resolves duplicate, incompatible and replicated medications as well administration incompatibilities by providing a single list of medications, dosages and routing that are compatible and valid following a drug interaction check, conflict check and administration review and verification. In another embodiment engine 42 automatically generates a consolidated new medication prescription list without manual interaction in step 240.

System 34 in step 250 generates HealthLevel 7 (HL7) format compatible transaction messages conveying the consolidated new medication prescription list to other systems. The other systems include a hospital pharmacy system 251, a patient medical record 253, physician and primary care specialist offices 257, an external system 260 and a patient personal computer 265. Further, external system 260 includes an external pharmacy, a benefits administrator, an employer and other authorized systems. System 34 documents changes in medications and associated dosages and methods of administration made in steps 235 and 240 by electronically communicating data in HL7 transaction format to an audit record in step 243 and to a prescription script record in step 247. The audit record and prescription script record may be retained in departmental systems 22, storage unit 14, memory 32 and client device 12. System 10 maintains an audit record in memory 32 (or unit 14 or device 12) indicating changes made to patient medication in response to the FIG. 2 process (with or without manual interaction) implementing industry best practices compatible with review organization (e.g., JCAHO) and national patient safety guidelines.

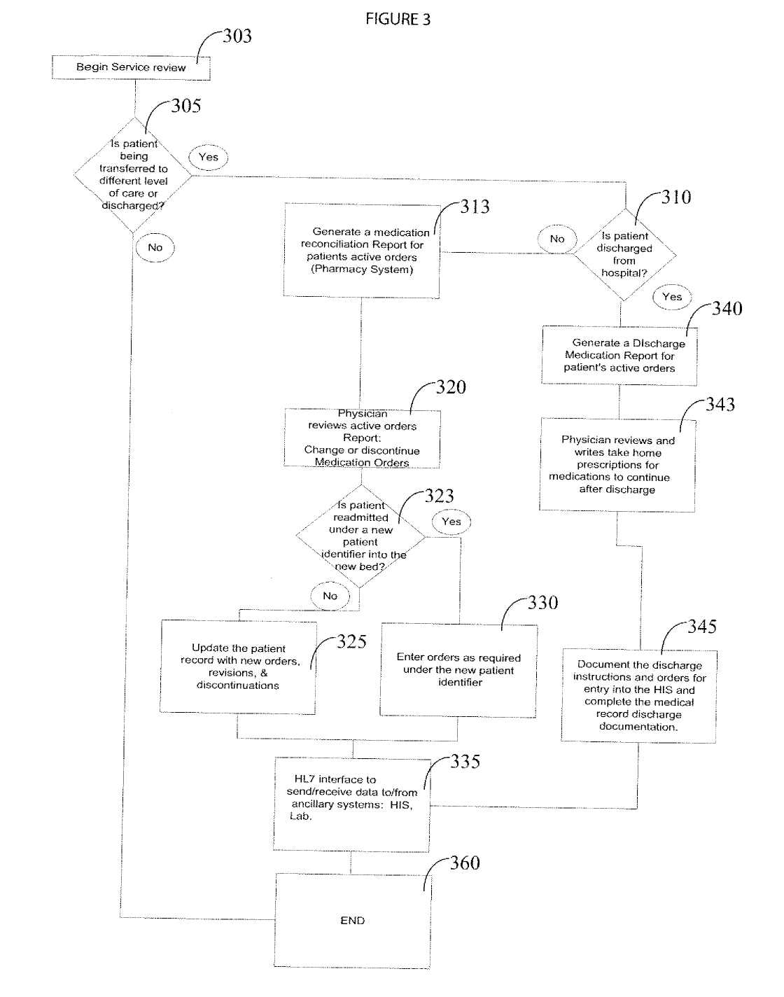

FIG. 3 shows a further flowchart of a process used by medication reconciliation system 34 in automatically reconciling orders for medications upon care setting transition. The process begins in response to a patient moving to a new care setting. Besides physically moving a patient, the healthcare worker (Nurse, ward clerk as examples) records a transfer or a discharge into Hospital Information System (HIS) 10 using a computer workstation (client device 12) keyboard or mouse to select from a menu of transfer or discharge actions. The FIG. 3 process is automatically initiated in response to detection and processing of the user-entered transfer or discharge action data based on predetermined information indicating locations, settings and setting transitions that require medication reconciliation. In an alternative embodiment, when a patient wearing an RFID band, or a Bluetooth device or miniature GPS tracking transponder or similar location detection technology device, changes location, system 10 automatically detects a location change and compares a new location with a previous location. System 10 prompts healthcare workers to complete a change location status data entry menu to indicate whether the patient is transferring to a different care setting. In response to receiving change location status data, medication reconciliation and Workflow system 34 automatically initiates a medication reconciliation process. If a healthcare worker does not respond to prompting to complete a change location status data entry menu, system 34 communicates an alert message to an authorized healthcare worker using at least one of multiple different predetermined prioritized communication methods identified in profile data of the healthcare worker. The predetermined prioritized communication methods include pager alerts or highlighting a patient record using color and flashing when the patient record is accessed, for example. System 34 employs an escalation procedure involving contacting a supervisor of a worker in the event the worker fails to respond to a prompt. Exception conditions, e.g., when a worker fails to responds to a prompt are logged in an audit record in unit 14 for evaluation.

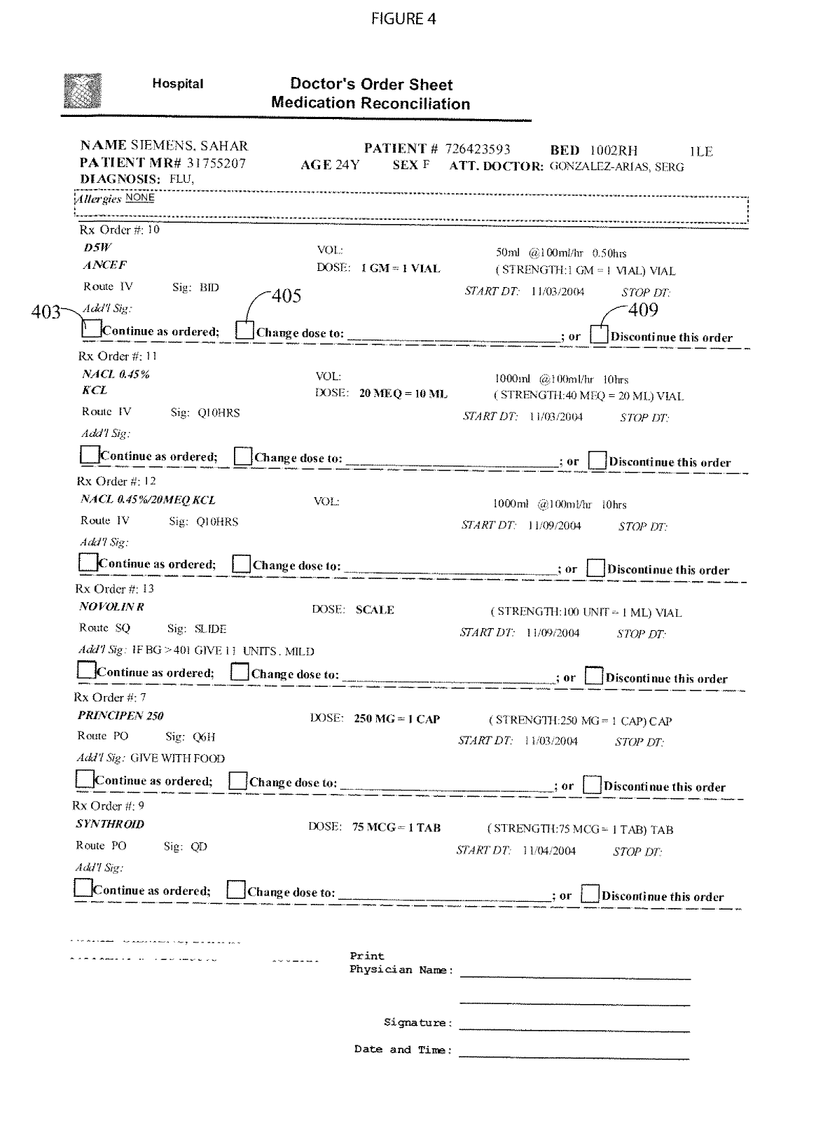

System 34 following initiation of a treatment service review in step 303, determines in step 305 whether a patient is being transferred to a different level of care or being discharged. If it is determined in step 305 that no transfer is occurring, the process ends in step 360. Otherwise system 34 determines in step 310 whether a patient is being discharged. If a patient is not being discharged, system 34 in step 313 generates a report indicating reconciled medications comprising patient active orders for review by a physician, for example, in step 320. A physician reviews and edits the active orders in the reconciled medications report in step 320 and may elect to change or discontinue individual medication orders. FIG. 4 illustrates a user interface display image or paper form supporting medication reconciliation. Specifically, the display image enables a user to select to continue a reconciled medication 403, change dosage 405 or discontinue a medication 409, for example. In another embodiment step 320 is omitted and an automatically generated reconciled medication report is employed.

In step 323, system 34 determines from patient related records in an ADT (Admission, Discharge, Transfer) system, for example, whether a patient is being readmitted with a new patient identifier into a new bed. This is done by searching admission records for different patient admission records with at least a portion of one patient specific identifier (medical record number, name, social security number or other identifier) being common to different records. If it is determined that the patient is readmitted with a new identifier, system 34 in step 330 associates orders in the generated reconciled medication report and any new orders added to this report, with the new patient identifier. If it is determined that the patient is not readmitted with a new identifier, system 34 in step 325 updates a patient medical record with the generated reconciled medication report information together with physician entered revisions, discontinuations and new medication orders. System 34 in step 335 employs an HL7 compatible interface for sending and receiving the generated reconciled medication report information, to and from ancillary systems and the process ends in step 360. The ancillary systems include an HIS, laboratory system, pharmacy system, patient administration system, financial system and other systems.

If system 34 determines in step 310 that a patient is being discharged, system 34 in step 340 generates a report indicating reconciled medications comprising patient active orders for use upon discharge for review by a physician, for example, in step 343. A physician reviews and edits the active orders in the reconciled medications discharge report in step 343 and may elect to change or discontinue individual medication orders in the discharge report taken home by a patient. In another embodiment, step 343 is omitted and an automatically generated reconciled medication report is employed. System 34 in step 345, documents the reconciled medications discharge report and associated medication orders in a record in an HIS and completes medical record discharge documentation. System 34 in step 335 employs an HL7 compatible interface for sending and receiving the generated reconciled medication report information, to and from ancillary systems and the process ends in step 360.

Medication reconciliation and Workflow system 34 adaptively selects and schedules Workflow tasks in performing medication reconciliation in response to detection of a patient care setting transition. System 34 is preferably implemented in software, but may also be implemented in hardware or a combination of both. The location of system 34 in server device 18 permits multiple systems and users to have access to medication reconciliation and Workflow system 34 from multiple client devices.

In exemplary operation, a male, 63 years old, enters a hospital emergency department with complaints of chest pain, numbness in upper left arm and shoulder, difficulty breathing, and chills. Following acquisition of an initial medical history and physical examination, the patient lists active medications as Norvasc (5 mg) and Cardora (16 mg) (doxazosin mesylate) for managing high blood pressure; Avodart (dutasteride) 0.5 mg daily for benign prostatic hyperplasia (BHP). The patient takes the following daily supplements: a multi-vitamin with minerals, baby aspirin (81 mg), fish oil capsule (1200 mg), selenium (200 mcg), vitamin E (400 IU), Selenium, and red rice yeast (120 mg). Upon onset of chest pain, the patient self-administered two 325 mg aspirin tablets. The prescribed medications, over the counter drugs, vitamins, and supplements are entered into Hospital Information System (HIS) 10 and sent to a pharmacy system as HL7 transactions to create a medication baseline. The emergency department, using ECG, diagnoses abnormal heart rates, consistent with acute MI (Myocardial Infarction). A physician orders t-PA, a clot-busting drug to be administered to the patient. The patient intake of vitamins and herbal supplements are discontinued. The patient is transferred to a surgical service for angioplasty and insertion of a drug-eluting stent in a blocked artery. Upon transfer into a surgical suite a cardiologist displays active medications, and notes no change to the patient active medications. The note is recorded in system 10 and pharmacy system 46.

After angioplasty-stent insertion, the patient is transferred first to a recovery room to stabilize and to monitor for post-procedure adverse reactions. After a reasonable period, the patient is transferred to the coronary care unit (CCU). His heart rate, pulse, and blood pressure is closely monitored and a catheter insertion site checked for bleeding. Upon patient admission to CCU, a physician reviews the patient active medications, using an attached reconciliation report provided by system 34 that was tailored to preferences of a particular hospital. The medication orders include continuing of aspirin, 81 mg and starting Plavix, a platelet inhibitor. Both the Pharmacy and system 10 are updated with the new orders. After 12 hours of stable monitoring in CCU, the patient is transferred to a cardiac step-down unit for post-procedure instructions, monitoring, and additional tests to rule out complications. After 24 hours and upon successful review of the patient condition, the physician discharges the patient from the hospital with medication instructions to continue to take Norvasc (5 mg), Cardura (16 mg), baby aspirin 81 mg daily. Additionally Plavix is prescribed to prevent blood clots and Zocor, 40 mg, is prescribed indefinitely. The patient is reminded to discontinue taking red rice yeast, as it reacts with Zocor, causing liver damage. The medication prescriptions are electronically sent as HL7 transactions to various destinations including, physicians, external pharmacy systems, benefits administrators, a patient home computer, and similar such systems as authorized by the patient, guarantor, and/or legal guardian. The patient receives written instructions from a pharmacy for taking the medications, to look for side effects and for drug interactions, The entire record of patient medication reconciliations is saved in the patient electronic health record as JCAHO compatible documentation, available for audit and display. System 10 supports Medication Reconciliation and medication profile sharing across multiple processing systems and automated Workflow used in medication identification, review, and renewal processes as well JCAHO compatible audit.

The data storage unit 14 stores patient records, as well as other information for the hospital information system 10. Alternatively, the patient records may be stored in the database 38 in the memory unit 32 in the server device 18, in the memory unit 28 in the client device 12, or in memory units in the departmental systems 22. Patient records may also be stored in multiple decentralized memory units among the data storage unit 14, the client device 12, the server device 18, and the departmental systems 22. Patient records in the data storage unit 14 generally include any information related to a patient including, without limitation, biographical, financial, clinical, Workflow, and care plan information.

The first local area network (LAN) 16 provides a communication network among the client device 12, the data storage unit 14 and the server device 18. The second local area network (LAN) 20 provides a communication network between the server device 18 and the departmental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol. The communication paths 52, 56, 60, 62, 64, 66, 68 and 70 each may be formed as a wired or wireless (W/WL) connection.

The server device 18 generally includes a processor 30, a memory unit 32, and patient treatment monitoring system 34. The memory unit 32 includes Workflow data and a database 38 containing patient records. Further, server device 18 may be implemented as a personal computer or a workstation. As previously mentioned, database 38 provides an alternate location for storing patient records, and user interface 23 is an alternate interface to interface 40 for a user. In the preferred embodiment of the present invention, medication reconciliation and Workflow system 34 is responsive to user interface 40 or user interface 23 in client device 12. In an alternative embodiment, medication reconciliation and Workflow system 24, including rules and Workflow engine 25 is responsive to user interface 23 in client device 12.

Departmental systems 22 are systems that need access to information or provide information related to the health and/or welfare of patients in the care of the healthcare provider. Examples of the departmental systems 22 include, without limitation, a lab system 44, a pharmacy system 46, a financial system 48 and a nursing system 50, as shown in FIG. 1, but may also include a records system, a radiology system, an accounting system, a billing system, and any other system required or desired in a healthcare information system.

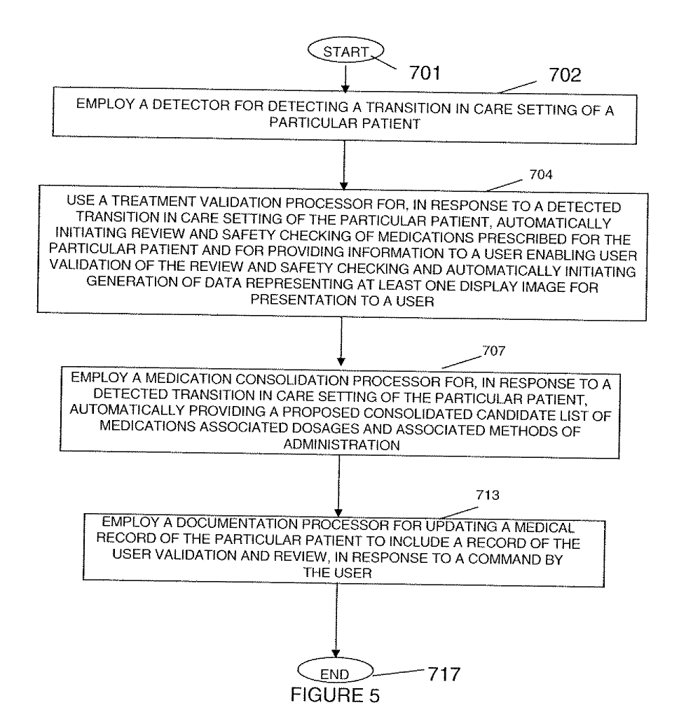

FIG. 5 shows a flowchart of a process performed by medication reconciliation and Workflow system 34 in providing a consolidated single medication list of a patient. In step 702 following the start at step 701 a detector in system 34 detects a transition in care setting of a particular patient. The detector detects the transition in care setting of the particular patient in response to detection of at least one of, a transition record entered into a healthcare information system and patient location data derived from a wireless patient location detection system. The transition in care setting comprises one or more of, an inpatient care setting to an outpatient care setting, an outpatient care setting to an inpatient care setting, a clinical imaging modality unit to a non-imaging modality unit, a non-intensive care setting to an intensive care setting or vice versa and a change in hospital inter-departmental care setting. A change in hospital inter-departmental care setting comprises a change between two of, (a) an intensive care unit, (b) a critical care unit, (c) a surgical unit, (d) an examination unit, (e) a physiotherapy unit, (f) an emergency unit, (g) an imaging unit, (h) an obstetrics/gynecology unit, (i) a pediatric unit, (j) a preventive care unit and (k) a radiology unit. The transition in care setting may also comprise a transition from a first healthcare facility to a different second healthcare facility care setting in which the first and second healthcare facilities are owned by different first and second healthcare provider organizations, respectively.

A treatment validation processor in system 34 in step 704, in response to a detected transition in care setting of the particular patient, automatically initiates review and safety checking of medications prescribed for the particular patient and provides information to a user enabling user validation of the review and safety check. The automatically initiated review and safety checking of medications prescribed for the particular patient comprises at least one of, a drug interaction check, a check of safety of a drug against the medical characteristics of the particular patient derived from a medical record of the particular patient and a check of duplicate drug names potentially indicating over prescription, The treatment validation processor also employs a user interface in automatically initiating generation of data representing at least one display image for presentation to a user. The at least one display image includes information enabling user review and safety checking of medications prescribed for the particular patient and enables user validation of the review and safety check. The at least one display image enables a user to confim and modify, a record indicating medications ordered for the particular patient. The at least one display image enables a user to modify the record indicating medications ordered for the particular patient by at least one of, canceling, changing and suspending, medications ordered for the particular patient. The provided information enabling user validation of the review and safety checking includes information indicating at least two of, medication dose, method of medication administration and medication administration procedure. An audit processor generates an audit record of the user validation and review in compliance with safety standard guidelines.

In step 707, a medication consolidation processor in system 34, in response to a detected transition in care setting of the particular patient, automatically initiates review and safety checking of medications prescribed for the particular patient and provides a proposed consolidated candidate list of medications associated dosages and associated methods of administration. The medication consolidation processor does this by identifying, duplicate, incompatible and replicated medications by text comparison of medication names and codes and by using medication code mapping information containing industry standard and other mapping information to support identifying duplicate or replicated medications. The medication consolidation processor provides a consolidated candidate list of medications from the proposed consolidated candidate list of medications in response to user command or in another embodiment, automatically. The medication consolidation processor provides the proposed consolidated candidate list of medications following a drug interaction, conflict check and administration review and verification and provides information to a user enabling user validation of the review and safety checking A documentation processor in system 34 in step 713 updates a medical record of the particular patient to include a record of the user validation and review, in response to a command by the user. A communication processor in system 34 communicates a message to a patient record management system using HL7 compatible communication protocol to update the medical record of the particular patient. The process of FIG. 5 terminates at step 717.

The systems and processes presented in FIGS. 1-5 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system according to invention principles is applicable to consolidating different treatments of a patient of any kind, not just medications (drugs), for example. Further, any of the functions provided in the system of FIG. 1 may be implemented in hardware, software or a combination of both and may reside on one or more processing devices located at any location of a network linking the FIG. 1 elements or another linked network including another intra-net or the Internet.

What is claimed is:

1. A medication reconciliation system for patients in different care settings, comprising:
a detector for detecting a transition in care setting of a particular patient;
a treatment validation processor for, in response to a detected transition in care setting of said particular patient, automatically initiating review and safety checking of medications prescribed for said particular patient and for providing information to a user enabling user validation of said review and safety checking; and
a documentation processor for updating a medical record of said particular patient to include a record of said user validation and review, in response to a command by said user.

2. A system according to claim 1, wherein
said detector detects said transition in care setting of said particular patient in response to detection of at least one of, (a) a transition record entered into a healthcare information system and (b) patient location data derived from a wireless patient location detection system.

3. A system according to claim 1, wherein
said automatically initiated review and safety checking of medications prescribed for said particular patient comprises at least one of, (a) a drug interaction check, (b) a check of safety of a drug against the medical characteristics of said particular patient derived from a medical record of said particular patient and (c) a check of duplicate drug names potentially indicating over prescription.

4. A system according to claim 1, wherein
said transition in care setting comprises at least one of, (a) a patient admission, (b) a patient discharge and (c) a patient transfer.

5. A system according to claim 1, including
a communication processor for communicating a message to a patient record management system to update said medical record of said particular patient.

6. A system according to claim 5, wherein
said communication processor uses HL7 compatible communication protocol for communicating said message.

7. A system according to claim 1, including
an audit processor for generating an audit record of said user validation and review in compliance with safety standard guidelines.

8. A system according to claim 1, including
a user interface for initiating generation of data representing at least one display image for presentation to a user, said at least one display image including said provided information enabling user validation of said review and safety checking.

9. A system according to claim 8, wherein
said at least one display image enables a user to at least one of, (a) confirm and (b) modify, a record indicating medications ordered for said particular patient.

10. A system according to claim 9, wherein
said at least one display image enables a user to modify said record indicating medications ordered for said particular patient by at least one of, (a) canceling, (b) changing and (c) suspending, medications ordered for said particular patient.

11. A system according to claim 8, wherein
said provided information enabling user validation of said review and safety checking includes information indicating at least two of, (a) medication dose, (b) method of medication administration and (c) medication administration procedure.

12. A system according to claim 1, wherein
said transition in care setting comprises at least one of, (a) an inpatient care setting to an outpatient care setting and (b) an outpatient care setting to an inpatient care setting.

13. A system according to claim 1, wherein
said transition in care setting comprises at least one of, (a) from a non-intensive care setting to an intensive care setting and (b) from an intensive care setting to a non-intensive care setting.

14. A system according to claim 1, wherein
said transition in care setting comprises a change in hospital inter-departmental care setting.

15. A system according to claim 13, wherein
said changed hospital inter-departmental care setting comprises a change between two of, (a) an intensive care unit, (b) a critical care unit, (c) a surgical unit, (d) an examination unit, (e) a physiotherapy unit, (f) an emergency unit, (g) an imaging unit, (h) an obstetrics/gynecology unit, (i) a pediatric unit, (j) a preventive care unit and (k) a radiology unit, (l) a laboratory unit, (m) chemotherapy unit, (n) a rehabilitation unit, and (p) psychiatric unit.

16. A system according to claim 1, wherein
said transition in care setting comprises a transition from a first healthcare facility to a different second healthcare facility care setting.

17. A system according to claim 16, wherein
said first and second healthcare facilities are owned by different first and second healthcare provider organizations, respectively.

18. A system according to claim 1, wherein
said transition in care setting comprises a transition from a clinical imaging modality unit to a non-imaging modality unit.

19. A medication reconciliation system, comprising:
a detector for detecting a transition in care setting of a particular patient;
a treatment validation processor for, in response to a detected transition in care setting of said particular patient, automatically initiating generation of data representing at least one display image for presentation to a user, said at least one display image including information enabling user review and safety checking of medications prescribed for said particular patient and enabling user validation of said review and safety checking; and
a documentation processor for updating a medical record of said particular patient to include a record of said user validation and review, in response to a command by said user.

20. A medication reconciliation system for patients in different care settings, comprising:
a detector for detecting a transition in care setting of a particular patient;
a medication consolidation processor for, in response to a detected transition in care setting of said particular patient, automatically initiating review and safety checking of medications prescribed for said particular patient and for providing a proposed consolidated candidate list of medications associated dosages and associated methods of administration; and
a documentation processor for updating a medical record of said particular patient to include a record of said user validation and review, in response to a command by said user.

21. A system according to claim 20, wherein
said medication consolidation processor provides a consolidated candidate list of medications from said proposed consolidated candidate list of medications in response to user command.

22. A system according to claim 20, wherein
said medication consolidation processor automatically provides a consolidated candidate list of medications from said proposed consolidated candidate list of medications.

23. A system according to claim 20, wherein
said medication consolidation processor provides information to a user enabling user validation of said review and safety checking.

24. A system according to claim 20, wherein
said medication consolidation processor provides said proposed consolidated candidate list of medications following a drug interaction, conflict check and administration review and verification.

25. A system according to claim 20, wherein
said medication consolidation processor provides said proposed consolidated candidate list of medications by identifying duplicate, incompatible and replicated medications by text comparison of medication names and codes and therapeutic categories.

26. A system according to claim 20, wherein
said medication processor provides said proposed consolidated candidate list of discontinued and suspended medications.

27. A system according to claim 20, wherein
said medication consolidation processor provides said proposed consolidated candidate list of medications using medication code mapping information containing industry standard and other mapping information to support identifying duplicate or replicated medications.
